(19) United States
(12) Patent Application Publication
(10) Pub. No.: US 2026/0223174 A1
(43) Pub. Date: Jul. 30, 2026

(54) FLEXIBLE ACKNOWLEDGEMENTS IN SCPP COMMUNICATION MODE

(71) Applicant: Telefonaktiebolaget LM Ericsson (publ), Stockholm (SE)

(72) Inventors: Abhishek AMBEDE, Huddinge (SE); Rocco DI TARANTO, Lund (SE); Leif WILHELMSSON, Lund (SE); Sebastian MAX, Cologne (DE); Dennis SUNDMAN, Sollentuna (SE); Guido Roland HIERTZ, Aachen (DE)

(21) Appl. No.: 19/158,212

(22) PCT Filed: Feb. 19, 2024
(86) PCT No.: PCT/EP2024/054168

§ 371 Date: Aug. 20, 2025

Related U.S. Application Data
(60) Provisional application No. 63/486,355, filed on Feb. 22, 2023.

(51) Int. Cl. H04W 74/0816; H04L 5/00; H04W 74/00

(52) U.S. Cl. CPC H04W 74/0816; H04L 5/0053; H04W 74/002

(57) ABSTRACT

A method, system and apparatus are disclosed. A network node (NN) configured to communicate with a wireless device (WD) is described. The network node is configured to, and/or includes a radio interface and/or processing circuitry configured to one or both of transmit one or more packets to the WD on a first sub-channel of a single operating channel; and receive one or more flexible acknowledgements (flexACKs) from the WD. The one or more flexACKs are received on at least a second sub-channel of the single operating channel and comprise acknowledgement information related to the reception by the WD of the one or more packets on the first sub-channel. The first and second sub-channels are different.

### FIELD

The present disclosure relates to wireless communications, and in particular, to wireless feedback communication.

### INTRODUCTION

In wireless communications, acknowledgement information may typically be exchanged between communicating devices, for example, to notify regarding successful and/or unsuccessful reception of packets containing information and/or data. Acknowledgements conveying successful reception of packets are generally termed positive acknowledgements, while acknowledgments conveying unsuccessful reception of packets are generally termed negative acknowledgements.

### Acknowledgements in IEEE 802.11 WLANs

In wireless communication networks such as based on standards promulgated by the Institute of Electrical and Electronics Engineers (IEEE) (e.g., IEEE 802.11 wireless local access networks (WLANs)), positive acknowledgement frames (ACKs) may be sent (e.g., from one station (STA) to another) to inform regarding successful reception of packets (e.g., Medium Access Control (MAC) Protocol Data Units (MPDUs) which are embedded inside Physical Layer (PHY) Protocol Data Units (PPDUs)).

### MAC-Level Acknowledgments

The reception of some frames requires the receiving STA to respond with an acknowledgment if the frame check sequence (FCS) of the received frame is correct. This technique is known as positive acknowledgment.

Lack of reception of an expected frame containing an acknowledgment indicates to the STA initiating the frame exchange that an error has occurred. However, the destination STA may have received the frame correctly, and the error may have occurred in the transfer or reception of the frame containing an acknowledgment. When a frame containing an acknowledgment is lost, the MAC that initiated the frame exchange does not receive a protocol indication of whether the initial frame was correctly received.

FIG. 1 shows a typical ACK transmission (e.g., in IEEE 802.11 WLANs) that occurs upon successful reception of a packet.

An IEEE 802.11 WLAN standard mandates that an ACK corresponding to the successful reception of a packet shall be transmitted by a STA using the same frequency resources as used for the packet that was received.

### Channel Width Selection for Control Frames

A mandatory rule is applicable for ACK transmissions (an ACK is an example of a control frame). More specifically, a STA that sends a Control frame in response to a frame carried in a high throughput (HT) PPDU or a very high throughput (VHT) PPDU shall set parameters (e.g., the TXVECTOR parameter CH_BANDWIDTH) to indicate a channel width that is the same as the channel width indicated by another parameter (the RXVECTOR parameter CH_BANDWIDTH) of the frame eliciting the response.

### Block Acknowledgement

The IEEE 802.11 WLAN standard supports a block acknowledgement mechanism which improves channel efficiency by aggregating several acknowledgments into one frame. In this mechanism, blocks of quality of service (QoS) data frames may be transmitted, e.g., from a first device to a second device. Thereafter, successfully received MPDUs within the block of frames are acknowledged by the second device by transmitting a BlockAck frame.

### Acknowledgement Possibilities in Multi-Link Operation in IEEE P802.11be Amendment

The IEEE P802.11be amendment, also termed as Extremely High Throughput (EHT) introduces a mode of communication called multi-link operation (MLO), where a device termed as a multi-link device (MLD) has multiple affiliated STAs, each of which can communicate using independent wireless channels (e.g., links). For example, an MLD can have two affiliated STAs—one communicating using a channel in the 5 GHz frequency band and the other communicating using a channel in the 6 GHz frequency band. Alternatively, as another example, an MLD can have two affiliated STAs—each communicating using channels in the 6 GHz frequency band. In MLO in EHT, a packet (e.g., MPDU) received on one link shall be acknowledged on the same link and may also be acknowledged on another link, only if that corresponding traffic identifier (TID) (i.e., an indicator of data type) is mapped to both links. Thus, it can be noted that in MLO in EHT, acknowledging packets on the same link as they are received on is mandatory whereas acknowledging packets received on one link using other link(s) is optional but conditional.

### Block ACK Procedures in Multi-Link Operation

A conventional STA affiliated with a recipient MLD shall provide (to the STA affiliated with the originator MLD that is operating on the same link) the reception status for any MPDU, with ACK policy other than No ACK, that is received on the link on which the STA affiliated with the recipient MLD is operating on. When a TID is mapped to more than one link, a STA affiliated with a recipient MLD may provide (if available), to the STA (affiliated with the originator MLD that is operating on the same link) reception status indicating successful reception of any MPDU, which belongs to that TID and has an ACK policy other than No ACKs, that is received by a STA affiliated with the recipient MLD that is operating on a different link.

### Single Channel Parallel Packets (SCPP) Communication Mode

In license-exempt frequency spectrum, there is an inherent uncertainty with regards to accessing the full desired amount of the wireless medium when needed, which prevents QoS requirements for the data to be supported in a reliable manner. It is typically observed that if devices (e.g., configured for Wi-Fi communication) do not sense the full desired channel bandwidth as being “idle”, the devices abort the corresponding attempt to communicate and make new attempts. Such last-moment cancellation of communication attempts even when communication would have been possible (on the idle portions of the desired channel bandwidth) could be disadvantageous for a device subject to stringent QoS requirements. For example, the device may suffer from large channel access delays of the order of many milliseconds.

A single channel parallel packets (SCPP) communication mode may be used. When using SCPP, a device prepares multiple narrow packets and sends them to another device in parallel using the different idle portions (e.g., sub-channels) of a wide operating channel. For example, the multiple packets may be sent, instead of attempting to send a single wide packet for which it would have to necessarily sense a correspondingly large amount of the operating channel bandwidth as being idle. Parallel packet transmissions may refer to there being at least some time overlap between the multiple packet transmissions and may not imply that the start times and/or the end times of the packets are aligned. FIG. 2 shows an example usage of SCPP mode.

Communicating using a SCPP mode by following existing acknowledgement procedures from the IEEE 802.11 WLAN standard (where an ACK corresponding to the successful reception of a packet is required to be transmitted using the same frequency resources as used for the packet that was received) may limit ACK transmissions. For example, as shown in FIG. 3, a device that successfully receives multiple parallel packets sent using multiple sub-channels of an operating channel may have to necessarily transmit ACKs for a particular received packet using the corresponding sub-channel over which it was received. That is, the ACK transmissions in the SCPP mode may not be able to take advantage of the flexibility offered by the ability to communicate in parallel using multiple sub-channels of the same single operating channel.

Further, as a consequence of having to use the same channel for sending the ACK, the channel has to allow at least two (consecutive) successful receptions (i.e., packet and corresponding ACK) for the packet communication to be successful.

### SUMMARY

Some embodiments advantageously provide methods, systems, and apparatuses for flexible acknowledgement of signaling (e.g., when SCPP communication mode is used).

An advantage of SCPP mode is simplification of implementation of channel access algorithms for hardware devices that operate in license-exempt frequency spectrum. The SCPP mode may also provide reliability improvements. One or more embodiments provide flexible ACK transmissions while operating using the SCPP mode.

Aspects are provided in the independent claims, and embodiments thereof are provided in the dependent claims.

One or more methods are described, i.e., methods for communicating acknowledgement information using flexible acknowledgements (flexACKs) in response to receiving multiple packets in parallel using different sub-channels of a single operating channel. In some embodiments, acknowledgement information using flexACKs is communicated while operating using the SCPP communication mode.

In some embodiments, a flexACK is transmitted on at least one sub-channel and may comprise acknowledgement information related to reception of a packet over at least one other sub-channel. In some other embodiments, flexACKs are transmitted using one or more (e.g., but not all sub-channels) that were used for packet transmission. In an embodiment, flexACKs are transmitted in parallel using all the sub-channels (e.g., for improved robustness). In another embodiment, one or more flexACKs are transmitted using sub-channels that were not used for transmitting a packet. Some embodiments provide enabling flexible sharing of acknowledgement information. In particular, by sending flexACKs corresponding to a packet sent on one sub-channel on two or more sub-channels, the problem of declaring a packet as erroneous due to a missed ACK is addressed (e.g., at least significantly reduced). Although, in some embodiments, the acknowledgement processes are described as to be used while communicating using the SCPP mode, the acknowledgment process (and/or related processes of the present disclosure) are not limited as such and can be used when communicating using any other communication mode (e.g., without using the SCPP mode).

One or more embodiments of the present disclosure are beneficial at least because acknowledgement associated with packet reception on at least one different sub-channel can be performed without it being necessary to also acknowledge on the sub-channel on which the packet was received, e.g., whereas in MLO in EHT or conventional single link communication in IEEE 802.11 WLANs, it is mandatory for the acknowledgment to occur on the same channel on which a packet is received. That is, one or more embodiments of the present disclosure provide for flexible acknowledgement signaling where one or more different channels can be used to transmit acknowledgement information. Further, one or more embodiments are related to communicating using sub-channels within a single channel (e.g., while operating using the SCPP mode).

According to one aspect, a method for communicating acknowledgement information is described. Communication of acknowledgment information may be performed when a packet transmitter and a packet receiver are communicating using SCPP mode over several sub-channels of a single operating channel. One or more flexible acknowledgements (flexACKs) may be transmitted by the packet receiver to the packet transmitter such that a flexACK transmitted on at least one sub-channel contains acknowledgement information related to the reception of a packet over at least one other sub-channel. The acknowledgement information may comprise information about successful and/or unsuccessful reception of one or more packets or other signaling.

In some embodiments, the one or more flexACKs are transmitted using a subset of the sub-channels, i.e., using one or more but not all sub-channels that were used for transmission of the packets.

In some other embodiments, one or more flexACKs are transmitted using one or more different sub-channels than the transmission of the packets, i.e., not the same sub-channels that were used for transmission of the packets.

In some embodiments, the choice of subset of the sub-channels is based on a listen-before-talk (LBT) process where the packet receiver checks availability of sub-channels.

In another embodiments, the flexACKs are transmitted in parallel using all the sub-channels that were used for transmission of the packets.

In some embodiments, the one or more flexACKs are transmitted only after the transmission duration of all the parallel packets is completed.

In some other embodiments, the start times of transmission of multiple parallel flexACKs are aligned (e.g., identical).

In an embodiment, at least one flexACK is transmitted on a sub-channel while still receiving one or more packets on other sub-channel(s).

In another embodiment, the end times of transmission of multiple parallel flexACKs are aligned (identical).

In some embodiments, the transmit parameters, such as modulation and coding schemes and/or number of spatial streams and/or transmit powers, etc., used for preparing (e.g., encoding) the multiple parallel flexACKs are not identical.

In some other embodiments, the acknowledgement information comprised in two or more, or all flexACKs is identical such as to improve the robustness/reliability of the flexACK transmissions.

In an embodiment, additional information such as buffer status reports, link adaptation feedback, channel quality feedback (e.g., in terms of signal-to-noise ratio (SNR), signal-to-noise and interference ratio (SINR), and/or interference and noise ratio (INR), etc.) is sent at the same time as the flexACK(s), using one or more of the sub-channels.

In another embodiment, the packet transmitter and/or the packet receiver undertake specific acknowledgement related signaling that helps to determine how the one or more flexACKs are communicated, for example, to determine which sub-channel(s) are/should be used for transmission of the one or more flexACKs.

In some embodiments, at least some of the acknowledgement related signaling occurs during the transmission of the one or more flexACKs, for example, using the preamble of at least one flexACK.

In some other embodiments, at least some of the acknowledgement related signaling occurs before transmission of the one or more flexACKs.

In some embodiments, at least some of the acknowledgement related signaling occurs during the transmission of the multiple parallel packets.

In another embodiment, at least some of the acknowledgement related signaling occurs using a control frame such as a trigger frame (TF), request-to-send (RTS) frame, clear-to-send (CTS) frame.

In some embodiments, at least some of the acknowledgement related signaling occurs using a management frame such as an (re-)association request frame, (re-)association response frame, probe request frame, probe response frame.

In some other embodiments, the wireless communications are based on a Wireless Local Area Network technology according to one or more IEEE 802.11 standard.

In an embodiment, the bandwidths of the one or more flexACKs are integer multiples of 20 MHz.

In another embodiment, the communication of acknowledgement information is performed using license-exempt frequency spectrum.

In some embodiments, the bandwidths of the one or more flexACKs are integer multiples of the clear channel assessment (CCA) resolution bandwidth.

According to one or more aspects, a device (e.g., a packet receiver, a wireless device, network node) is configured for communication of acknowledgment information. The device (and/or any of its components) may be configured to transmit one or more flexible acknowledgements (flexACKs) to another device (e.g., the packet transmitter, network node, wireless device) such that a flexACK transmitted on at least one sub-channel comprises acknowledgement information related to the reception of a packet over at least one other sub-channel. The acknowledgement information may comprise information about successful and/or unsuccessful reception of one or more packets or other signaling.

According to one or more aspects, a device (e.g., a packet transmitter, network node, a wireless device) is configured for communication of acknowledgment information. The device (and/or any of its components) may be configured to receive one or more flexible acknowledgements (flexACKs) from another device (e.g., the packet receiver, network node, wireless device) such that a flexACK received on at least one sub-channel comprises acknowledgement information related to the reception of a packet over at least one other sub-channel. The acknowledgement information may comprise information about successful and/or unsuccessful reception of one or more packets or other signaling.

One or more embodiments improve (e.g., when compared to conventional technology) the ability of communicating in parallel using multiple sub-channels for sharing acknowledgement information. Further, one or more embodiments, where sharing acknowledgement information is performed, provide improved flexibility for the communicating devices (e.g., when compared to conventional technology). For example, not having to use all sub-channels that were used for packets also for flexACKs allows leaving some sub-channels free to use by other devices or for simultaneously sending additional information such as buffer status reports (BSRs), link adaptation (LA) feedback, channel quality feedback (e.g., in terms of SNR/SINR/INR), etc. The restriction of effectively requiring two successful receptions (of a packet and its corresponding ACK) for every transmission can also be avoided due to the flexibility offered in one or more embodiments of the present disclosure. Another advantage includes achieving improved reliability and/or robustness of the flexACK transmissions when multiple copies of the same flexACK are transmitted on several sub-channels.

According to another aspect, a network node (NN) configured to communicate with a wireless device (WD) is described. The network node is configured to, and/or comprises a radio interface and/or processing circuitry configured to transmit one or more packets to the WD on a first sub-channel of a single operating channel; and receive one or more acknowledgements (ACKs) from the WD. The one or more ACKs are received on at least a second sub-channel of the single operating channel and comprise acknowledgement information related to the reception by the WD of the one or more packets on the first sub-channel. The first and second sub-channels are different.

According to one aspect, a method in a network node (NN) configured to communicate with a wireless device (WD) is described. The method comprises transmitting one or more packets to the WD on a first sub-channel of a single operating channel; and receiving one or more acknowledgements (ACKs) from the WD. The one or more ACKs are received on at least a second sub-channel of the single operating channel and comprise acknowledgement information related to the reception by the WD of the one or more packets on the first sub-channel. The first and second sub-channels are different.

According to another aspect, a wireless device (WD) configured to communicate with a network node (NN) is described. The WD is configured to, and/or comprises a radio interface and/or processing circuitry configured to receive one or more packets from the NN on a first sub-channel of a single operating channel; and transmit one or more acknowledgements (ACKs) to the NN. The one or more ACKs are transmitted on at least a second sub-channel of the single operating channel and comprise acknowledgement information related to the reception by the WD of the one or more packets on the first sub-channel. The first and second sub-channels are different.

According to one aspect, a method in a wireless device (WD) configured to communicate with a network node (NN) is described. The method comprises receiving one or more packets from the NN on a first sub-channel of a single operating channel and transmitting one or more acknowledgements (ACKs) to the NN. The one or more ACKs are transmitted on at least a second sub-channel of the single operating channel and comprise acknowledgement information related to the reception by the WD of the one or more packets on the first sub-channel. The first and second sub-channels are different.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows a typical ACK transmission that occurs upon successful reception of a packet;

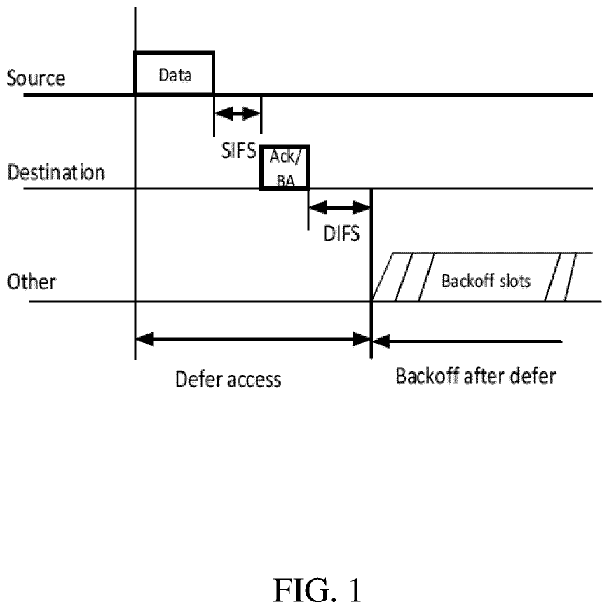

FIG. 2 shows an example usage of SCPP mode;

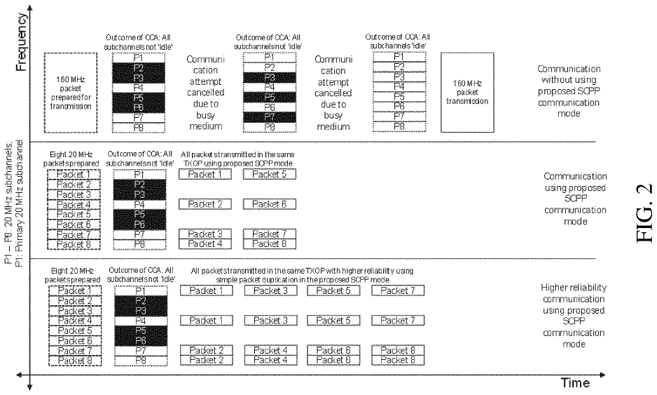

FIG. 3 shows ACKs that may be transmitted using conventional technology for acknowledging while communicating using SCPP mode;

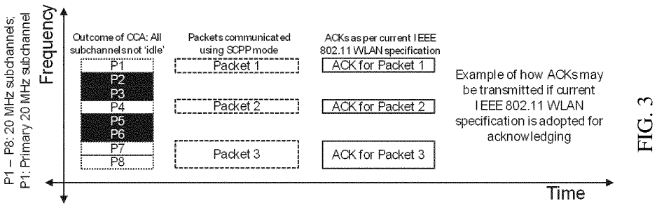

FIG. 4 is a schematic diagram of an example network architecture illustrating a communication system according to principles disclosed herein;

FIG. 5 is a block diagram of a network node in communication with a wireless device over a wireless connection according to some embodiments of the present disclosure;

FIG. 6 is a flowchart of a nonlimiting example process in a network node according to some embodiments of the present disclosure;

FIG. 7 is a flowchart of a nonlimiting example process in a wireless device according to some embodiments of the present disclosure; and

FIG. 8 shows examples of how flexACKs may be transmitted for acknowledging while communicating using the SCPP mode according to some embodiments of the present disclosure.

### DETAILED DESCRIPTION

Before describing in detail exemplary embodiments, it is noted that the embodiments reside primarily in combinations of apparatus components and processing steps related to flexible acknowledgement of signaling (e.g., when SCPP communication mode is used). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In some embodiments, the term flexACK is used and may refer to signaling (e.g., frames) associated with a feedback process (e.g., acknowledgement process, ACK, NACK, etc.). In some embodiments, flexACK is used to highlight the flexibility associated with the content of the acknowledgement frames, as well as the flexibility associated with the different proposed ways in which the flexACKs can be communicated.

In some embodiments, the term device is used and may refer to a device configurable to communicate (e.g., using one or more wireless/wired communication links) to another device. In some embodiments, the device may comprise a wireless device, a node such as a network node, a packet transmitter, a packet receiver, etc. In some other embodiments, the device may be configured to communicate using one or more protocols and/or based on a communication standard such as IEEE 802.11 WLAN. In some embodiments, the device may be a wireless router and/or access point (AP) and/or a station (STA) (e.g., configured for Wi-Fi communications).

The term “network node” used herein can be any kind of network node and may comprise a base station, a router, network switch, firewall, an AP, etc. The network node may be configured for communication using one or more protocols (e.g., configured for Wi-Fi communications).

The term wireless device (WD) used herein can be any kind of wireless and may comprise any device configured to communicate with another device such as an STA, mobile device, etc. The WD may be configured for communication using one or more protocols (e.g., configured for Wi-Fi communications).

In some embodiments, the NN may be configured to perform WD functions (e.g., be a WD). Similarly, in some other embodiments, the WD may be configured to perform NN functions (e.g., be a NN). In some embodiments, a WD may be configured to communicate with one or more NN and/or other WDs. Similarly, in some other embodiments, a NN may be configured to communicate with one or more WDs and/or other NNs. In a nonlimiting example, a NN may be configured to send data to a WD, and the WD may be configured to send flexACKs. In another nonlimiting example, the WD may be configured to send data to a NN, and the NN may be configured to send flexACKs. In a nonlimiting example, the NN may be configured to send data to another NN, and the other NN may be configured to send flexACKs. In another nonlimiting example, the WD may be configured to send data to another WD, and the other WD may be configured to send flexACKs. Further, any one of the NN and/or WD may comprise an AP or a STA, where communication of packets and/or flexible acknowledgments (flexACKs) may comprise transmission of packets and/or flexible acknowledgments (flexACKs) from the AP to the STA, from the STA to the AP, from the AP to another AP, and from the STA to another STA. In other words, while the terms NN and WD are used herein to describe devices with particular functionality, the functions of an NN and a WD as relate to the functions disclosed herein may both be considered “devices” where a first device sends data to a second “device”.

In some embodiments, one or more of the NN and WD may be associated with Third Generation Partnership Project (3GPP) standards. The 3GPP has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

In some embodiments, (e.g., related to 3GPP implementations), the network node may be comprised in a radio network. The network node may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or user equipment (UE) may be used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

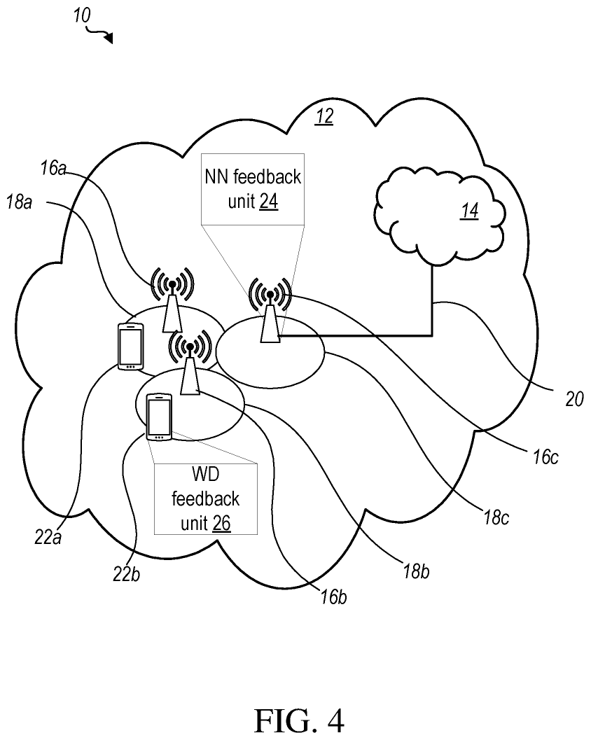

Referring again to the drawing figures, in which like elements are referred to by like reference numerals, there is shown in FIG. 4 a schematic diagram of a communication system 10, according to an embodiment, such as an IEEE 802.11 network. In some embodiments, the network may be a 3GPP-type cellular network that may support standards such as LTE and/or NR (5G). The system 10 may comprise network 12 (e.g., a WLAN, an access network, a radio access network). Further, system 10 may comprise network 14 (e.g., a core network, internet, any other network). The network 12 comprises a plurality of network nodes 16a, 16b, 16c (referred to collectively as network nodes 16), such as APs or other types of wireless access points, each defining a corresponding coverage area 18a, 18b, 18c (referred to collectively as coverage areas 18). Each network node 16a, 16b, 16c is connectable to the core network 14 over a wired or wireless connection 20 and/or may communicate to other network nodes in any other network such as network 14. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports a communication protocol (or radio access technology) and the same or a different network node 16 that supports another communication protocol (and/or another radio access technology). In some embodiments, one or more WD 22 may be configured to communicate with another WD 22 using any protocol such as Wi-Fi, Wi-Fi direct, sidelink, etc.

A network node 16 (e.g., an AP, or any other node) is configured to include a NN feedback unit 24 which is configured to perform any step and/or task and/or process and/or method and/or feature described in the present disclosure, e.g., transmit one or more packets; receive a flexACK, received on at least one sub-channel, comprises acknowledgement information related to the reception (by another device such as WD 22) of the one or more packets over at least one other sub-channel. A wireless device 22 is configured to include WD feedback unit 26 which is configured to perform any step and/or task and/or process and/or method and/or feature described in the present disclosure, e.g., receive one or more packets; transmit a flexACK, transmitted on at least one sub-channel, comprises acknowledgement information related to the reception (by the WD 22) of the one or more packets over at least one other sub-channel. In some embodiments, NN feedback unit 24 is configured to perform the functions of WD feedback unit 26. In some other embodiments, WD feedback unit 260 is configured to perform the functions of NN feedback unit 24.

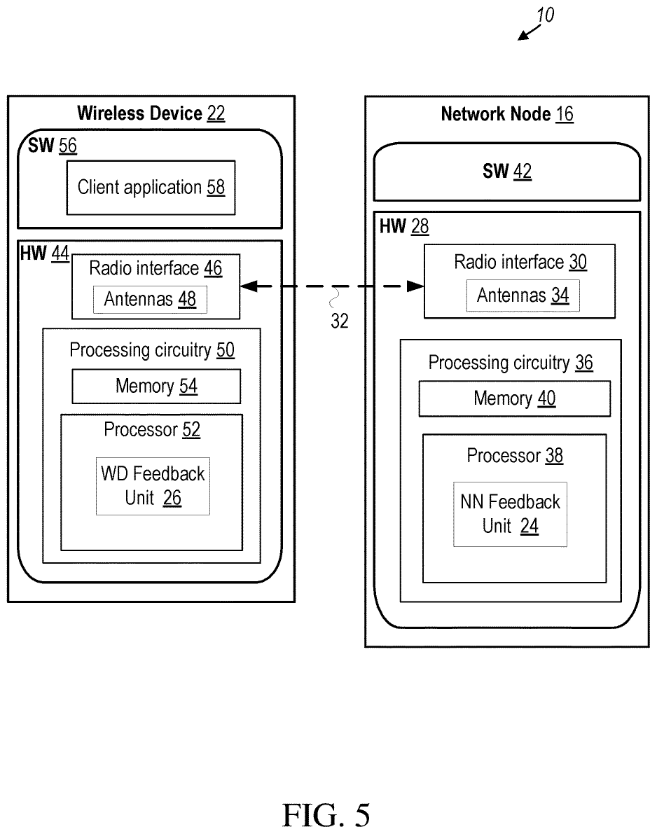

Example implementations, in accordance with an embodiment, of the WD 22 and network node 16 discussed in the preceding paragraphs will now be described with reference to FIG. 5.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include NN feedback unit 24 which is configured to perform any step and/or task and/or process and/or method and/or feature described in the present disclosure, e.g., transmit one or more packets; receive a flexACK, received on at least one sub-channel, comprises acknowledgement information related to the reception (by another device such as WD 22) of the one or more packets over at least one other sub-channel.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include WD feedback unit 26 which is configured to perform any step and/or task and/or process and/or method and/or feature described in the present disclosure, e.g., receive one or more packets; transmit a flexACK, transmitted on at least one sub-channel, comprises acknowledgement information related to the reception (by the WD 22) of the one or more packets over at least one other sub-channel.

In some embodiments, the inner workings of the network node 16 and WD 22 may be as shown in FIG. 5 and independently, the surrounding network topology may be that of FIG. 4.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 4 and 5 show various “units” such as NN feedback unit 24 and WD feedback unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

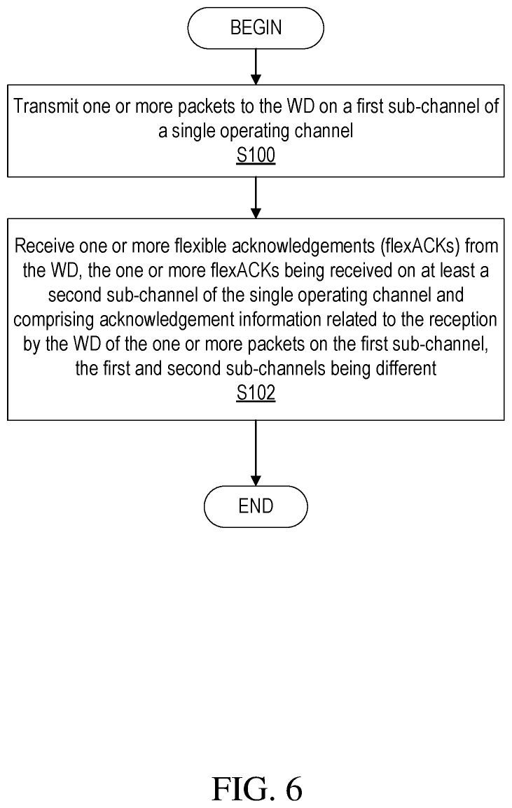

FIG. 6 is a flowchart of a nonlimiting example process in a network node 16 (e.g., packet transmitter). One or more blocks described herein may be performed by one or more elements of network node 16 such as by one or more of processing circuitry 36 (including the NN feedback unit 24), processor 38, and/or radio interface 30. Network node 16 such as via processing circuitry 36 and/or processor 38 and/or radio interface 30 is configured to transmit (Block S100) one or more packets to the WD 22 on a first sub-channel of a single operating channel; and receive (Block S102) one or more flexible acknowledgements (flexACKs) from the WD 22. The one or more flexACKs are received on at least a second sub-channel of the single operating channel and comprising acknowledgement information related to the reception by the WD 22 of the one or more packets on the first sub-channel. The first and second sub-channels are different. Although FIG. 6 has been described as a nonlimiting example process in a network node 16, any of the steps and/or tasks and/or processes and/or methods and/or features described in the present disclosure, e.g., including FIG. 6, may be performed by WD 22 (and/or any other component of system 10).

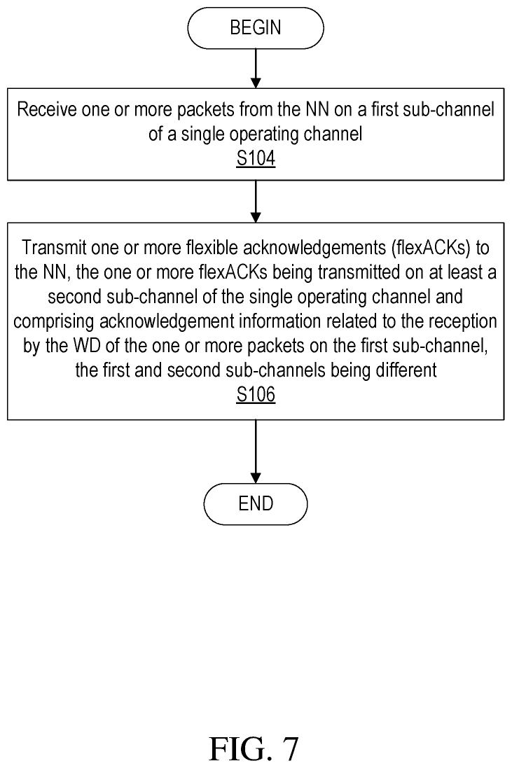

FIG. 7 is a flowchart of a nonlimiting example process in a wireless device 22 according to some embodiments of the present disclosure. One or more blocks described herein may be performed by one or more elements of wireless device 22 such as by one or more of processing circuitry 50 (including the WD feedback unit 26), processor 52, and/or radio interface 46. Wireless device 22 such as via processing circuitry 50 and/or processor 52 and/or radio interface 46 is configured to receive (Block S104) one or more packets from the NN 16 on a first sub-channel of a single operating channel; and transmit (Block S106) one or more flexible acknowledgements (flexACKs) to the NN 16. The one or more flexACKs are transmitted on at least a second sub-channel of the single operating channel and comprising acknowledgement information related to the reception by the WD 22 of the one or more packets on the first sub-channel. The first and second sub-channels are different. Although FIG. 7 has been described as a nonlimiting example process in a WD 22, any of the steps and/or tasks and/or processes and/or methods and/or features described in the present disclosure, e.g., including FIG. 7, may be performed by NN 16 (and/or any other component of system 10).

Having described the general process flow of arrangements of the disclosure and having provided examples of hardware and software arrangements for implementing the processes and functions of the disclosure, the sections below provide details and examples of arrangements for flexible acknowledgement of signaling (e.g., when SCPP communication mode is used).

One or more methods (apparatuses and/or systems) for sharing acknowledgement information using flexible acknowledgements (flexACKs) are introduced. In some embodiments, the term flexACK may be used to highlight the flexibility associated with the content of the acknowledgement frames and/or different ways in which the flexACKs can be communicated.

In a main embodiment, when NN 16 (e.g., packet transmitter) and WD 22 (e.g., a packet receiver) are communicating using the SCPP mode over different sub-channels of a single operating channel, one or more flexACKs are transmitted by WD 22 to NN 16 such that a flexACK transmitted on at least one sub-channel comprises acknowledgement information related to the reception of a packet over at least one other sub-channel. This allows for multiple flexible scenarios. For example, acknowledgement information for a packet received on one sub-channel is transmitted on that sub-channel as well as on another sub-channel. In another example, acknowledgement information for a packet received on one sub-channel is not transmitted on that sub-channel but on another sub-channel. Furthermore, acknowledgement information in the flexACKs may comprise information about successful and/or unsuccessful reception. Although flexACKs of this embodiment have been described as being transmitted by WD 22, flexACKs (and/or any other signaling) may be transmitted by any other device/node such as NN 16.

In another embodiment, one or more flexACKs are transmitted using a subset of the sub-channels, i.e., using one or more but not all sub-channels that were used for transmission of the packets. This may allow for freeing up one or more sub-channels for other purposes or for use by other devices. In addition, transmitting flexACKs on some of the sub-channels that have been used for the packet transmission may interfere with other ongoing transmissions, where not sending a flexACK on these sub-channels would enhance coexistence with other devices. That is, WD 22 (e.g., packet receiver) may (e.g., optionally) perform listen before talk (LBT) on all sub-channels where packets are received and which are suitable candidates for sending flexACKs, but then based on the outcome of the LBT only transmit flexACKs on the sub-channels found to be available.

In some embodiments, WD 22 (e.g., packet receiver) may (optionally) perform LBT on all sub-channels (i.e., not only on those where packets were transmitted), and based on the outcome of the LBT transmit flexACKs on one or more sub-channels found to be available. This may result in that one or more flexACKs are transmitted on sub-channels that were not used for transmission of the packets. This embodiment may be particularly useful if the packet receiver knows (for example through signaling/NAV/ etc.) that a certain sub-channel is or may be available.

In some other embodiments, the flexACKs are transmitted in parallel using all the sub-channels that were used for transmission of the packets, which may improve the reliability of the flexACK transmissions, such as, by including the same acknowledgement information in multiple flexACKs across different sub-channels.

The term parallel flexACK transmissions may refer to there being at least some time overlap between the multiple flexACK transmissions and may not necessarily imply that the start times and/or the end times of the flexACK are aligned.

### Timing Related Embodiments

In another embodiment, the one or more flexACKs are transmitted only after the transmission duration of all the parallel packets is completed. This could help to ensure that a situation where a device (e.g., WD 22) transmits a flexACK on one sub-channel (while still receiving a packet on another sub-channel does not arise). In an embodiment, the start times for the transmission of multiple parallel flexACKs are aligned (e.g., identical).

In some embodiments, at least one flexACK is transmitted on a sub-channel while still receiving one or more packets on other sub-channel(s). This may be possible for a device if it is capable of transmitting on some frequency resources while simultaneously receiving on some frequency resources of the same channel. Depending on the capability of the device, the frequency resources used for transmission may or may not overlap with the frequency resources used for simultaneous reception.

In some other embodiments, the end times of transmission of multiple parallel flexACKs are aligned (identical). This could help to, for example, free up the frequency resources corresponding to all the used sub-channels at the same time.

### Flexibility Related Embodiments

In an embodiment, transmit parameters, such as modulation and coding schemes (MCSs) and/or number of spatial streams and/or transmit powers etc., used for preparing (encoding) the multiple parallel flexACKs are not identical. This may help to encode the flexACKs such that they feature different levels of robustness.

In another embodiment, the acknowledgement information contained in two or more flexACKs is identical to improve the reliability of the flexACK transmissions.

In some embodiments, additional information such as BSRs, link adaptation (LA) feedback, channel quality feedback (e.g., in terms of SNR/SINR/INR), etc. is sent at the same time as the flexACK(s), using one or more of the sub-channels. This can provide increased flexibility, for example, flexACKs and additional information may be transmitted at the same time using different sub-channels.

In some other embodiments, if WD 22 (e.g., the packet receiver) knows (or can estimate) the number/identity of sub-channels NN 16 (e.g., the packet transmitter) attempted to transmit on, the acknowledgement information may comprise sub-channel specific information regarding unsuccessful reception. For example, if high interference was experienced on certain sub-channels leading to unsuccessful reception, or if preambles of packets were detected but not data parts on certain sub-channels. Of course, on some sub-channels there may have been no packet transmission at all, in which case NN 16 (e.g., packet transmitter) can ignore the corresponding feedback. However, also for sub-channels where on packets have been sent, WD 22 (e.g., the packet receiver) may send back information related to the channel quality, e.g., whether the packet receiver experience interference on these sub-channels or not. This information may be used at a later time by NN 16 (e.g., the packet transmitter) to select a suitable MCS to use.

### Signaling Related Embodiments

In an embodiment, NN 16 (e.g., the packet transmitter) and/or WD 22 (e.g., the packet receiver) undertake specific acknowledgement related signaling that helps to determine how the one or more flexACKs are communicated, for example, to determine which sub-channel(s) are/should be used for transmission of the one or more flexACKs. This determining may be based on negotiation between the two devices (i.e., NN 16 and WD 22), or simply on one of the devices announcing how the flexACKs are/should be communicated.

In another embodiment, at least some of the acknowledgement related signaling occurs during the transmission of the one or more flexACKs, for example, using the preamble of at least one flexACK.

In some embodiments, at least some of the acknowledgement related signaling occurs before transmission of the one or more flexACKs. In some other embodiments, at least some of the acknowledgement related signaling occurs during the transmission of the multiple parallel packets. In an embodiment, at least some of the acknowledgement related signaling occurs using a control frame such as a trigger frame (TF), request-to-send (RTS) frame, clear-to-send (CTS) frame. In another embodiment, at least some of the acknowledgement related signaling occurs using a management frame such as an (re-)association request frame, (re-)association response frame, probe request frame, or probe response frame.

### Miscellaneous Embodiments

In some embodiments, the wireless communications are based on a Wireless Local Area Network technology according to the IEEE 802.11 standards family.

In some other embodiments, the bandwidths of the one or more flexACKs are integer multiples of 20 MHz.

In an embodiment, the communication of acknowledgement information is performed using license-exempt frequency spectrum. In another embodiment, the bandwidths of the one or more flexACKs are integer multiples of the clear channel assessment (CCA) resolution bandwidth.

### Examples of Usage of Proposed Acknowledgement Solutions While Communicating Using the SCPP Mode

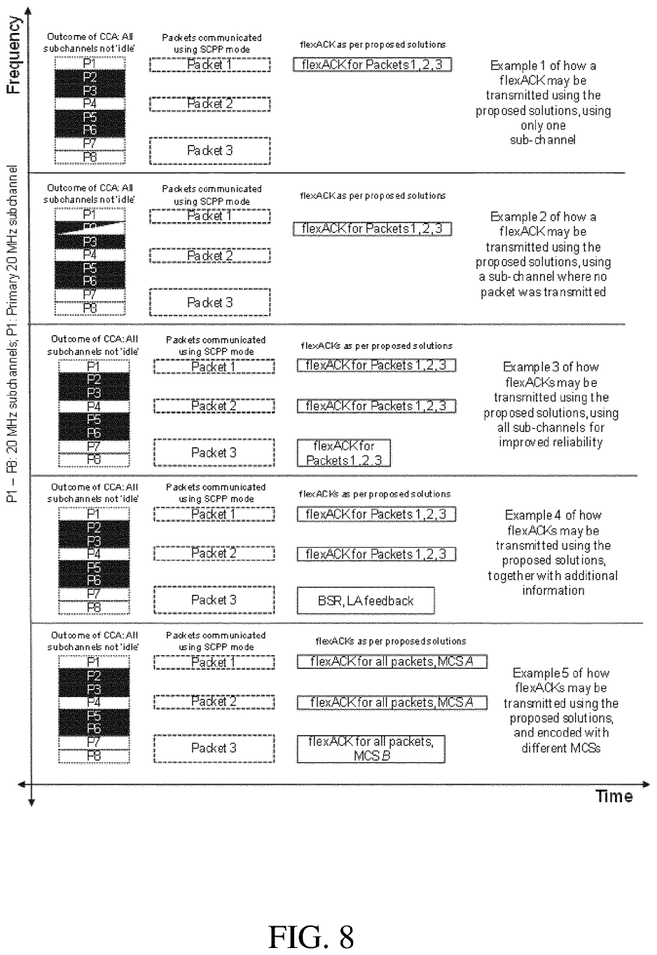

FIG. 8 illustrates multiple examples of how flexACKs may be transmitted for acknowledging while communicating using the SCPP mode.

### Usage of the Acknowledgement Solutions/Processes When Communicating Without Using the SCPP Mode

In some embodiments, acknowledgement methods may be used in combination with other methods (i.e., methods associated with the SCPP communication mode). One or more methods provide a channel access procedure enabling simultaneous transmissions over multiple sub-channels of a single channel. In some other embodiments, the acknowledgement methods (e.g., tailored to that several parallel transmissions may occur using SCPP mode) may be used. For example, a packet need not be acknowledged necessarily on the same sub-channel that was used for its transmission.

Although one or more embodiments may be used when SCPP mode is applied, the embodiments of the present disclosure are not limited as such and may be used where no SCPP mode is used or applied and/or when other communication modes are used. For example, when MLO is used, acknowledgement methods may be used to further enhance the flexibility to acknowledge across multiple links. In some embodiments, even the baseline single link communication in IEEE 802.11 WLANs can be enhanced by adapting the acknowledgement procedures of the present disclosure. For example, in response to receiving a single packet over 80 MHz, instead of sending an 80 MHz ACK, multiple narrower flexACKs in parallel may be sent—for example, to improve reliability of the acknowledgements. Some example embodiments:

According to one or more aspects, one or more of the following embodiments are described.
1. A method for communicating acknowledgement information when a packet transmitter and a packet receiver are communicating using the SCPP mode over several sub-channels of a single operating channel, wherein one or more flexible acknowledgements (flexACKs) are transmitted by the packet receiver to the packet transmitter such that a flexACK transmitted on at least one sub-channel contains acknowledgement information related to the reception of a packet over at least one other sub-channel, wherein the acknowledgement information contains information about successful and/or unsuccessful reception.
2. The method according to Embodiment 1, wherein the one or more flexACKs are transmitted using a subset of the sub-channels, i.e., using one or more but not all sub-channels that were used for transmission of the packets.
3. The method according to any one of the preceding Embodiments, wherein one or more flexACKs are transmitted using different sub-channels than the transmission of the packets, i.e., not the same sub-channels that were used for transmission of the packets.
4. The method according to any one of the preceding Embodiments, wherein the choice of subset of the sub-channels is based on a listen-before-talk (LBT) process where the packet receiver checks availability of sub-channels.
5. The method according to Embodiment 1, wherein the flexACKs are transmitted in parallel using all the sub-channels that were used for transmission of the packets.
6. The method according to any one of the preceding Embodiments, wherein the one or more flexACKs are transmitted only after the transmission duration of all the parallel packets is completed.
7. The method according to Embodiment 6, wherein the start times of transmission of multiple parallel flexACKs are aligned (identical).
8. The method according to any one of Embodiments 1-5, wherein at least one flexACK is transmitted on a sub-channel while still receiving one or more packets on other sub-channel(s).
9. The method according to any one of the preceding Embodiments, wherein the end times of transmission of multiple parallel flexACKs are aligned (identical).
10. The method according to any one of the preceding Embodiments, wherein the transmit parameters, such as modulation and coding schemes and/or number of spatial streams and/or transmit powers etc., used for preparing (encoding) the multiple parallel flexACKs are not identical.
11. The method according to any one of the preceding Embodiments, wherein the acknowledgement information contained in two or more, or all flexACKs is identical to improve the robustness/reliability of the flexACK transmissions.
12. The method according to any one of the preceding Embodiments, wherein additional information such as buffer status reports, link adaptation feedback, channel quality feedback (e.g., in terms of SNR/SINR/INR), etc. is sent at the same time as the flexACK(s), using one or more of the sub-channels.
13. The method according to any one of the preceding Embodiments, wherein the packet transmitter and/or the packet receiver undertake specific acknowledgement related signaling that helps to determine how the one or more flexACKs are communicated, for example, to determine which sub-channel(s) are/should be used for transmission of the one or more flexACKs.
14. The method according to Embodiment 13, wherein at least some of the acknowledgement related signaling occurs during the transmission of the one or more flexACKs, for example, using the preamble of at least one flexACK.
15. The method according to Embodiment 13, wherein at least some of the acknowledgement related signaling occurs before transmission of the one or more flexACKs.
16. The method according to Embodiment 15, wherein at least some of the acknowledgement related signaling occurs during the transmission of the multiple parallel packets.
17. The method according to Embodiment 15, wherein at least some of the acknowledgement related signaling occurs using a control frame such as a trigger frame, request-to-send (RTS) frame, clear-to-send (CTS) frame.
18. The method according to Embodiment 15, wherein at least some of the acknowledgement related signaling occurs using a management frame such as an (re-)association request frame, (re-)association response frame, probe request frame, probe response frame.
19. The method according to any one of the preceding Embodiments, wherein the wireless communications are based on a Wireless Local Area Network technology according to the IEEE 802.11 family of standards.
20. The method according to any one of the preceding Embodiments, wherein the bandwidths of the one or more flexACKs are integer multiples of 20 MHz.
21. The method according to any one of the preceding Embodiments, wherein the communication of acknowledgement information is performed using license-exempt frequency spectrum.
22. The method according to Embodiment 21, wherein the bandwidths of the one or more flexACKs are integer multiples of the clear channel assessment (CCA) resolution bandwidth.
23. A device (e.g., packet receiver) configured to perform one or more steps of Embodiments 1-22 such as transmit the acknowledgement information.
24. Another device (e.g., packet transmitter) configured to perform one or more steps of Embodiments 1-22 such as receive the acknowledgement information.
23. A system (e.g., comprising NN 16, WD 22, or any other component of system 10) configured to perform one or more of the steps corresponding to Embodiments 1-22.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
ACK Acknowledgement Frame
BSR Buffer Status Report
CCA Clear Channel Assessment
CTS Clear-To-Send
EHT Extremely High Throughput
FCS Frame Check Sequence
flexACK flexible Acknowledgement Frame
INR Interference to Noise Ratio
LA Link Adaptation
LBT Listen Before Talk
MAC Medium Access Control
MCS Modulation and Coding Scheme
MLO Multi-Link Operation
MPDU Medium Access Control (MAC) Protocol Data Unit
PHY Physical Layer
PPDU Physical Layer (PHY) Protocol Data Unit
QoS Quality of Service
RTS Request-To-Send
SCPP Single Channel Parallel Packets
SINR Signal to Interference plus Noise Ratio
SNR Signal to Noise Ratio
STA Station
TID Traffic Identifier
WLAN Wireless Local Area Network

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings and following example embodiments.

### Example Embodiments

Embodiment A1. A network node (NN) configured to communicate with a wireless device (WD), the network node configured to, and/or comprising a radio interface and/or comprising processing circuitry configured to:
transmit one or more packets to the WD on a first sub-channel of a single operating channel; and
receive one or more flexible acknowledgements (flexACKs) from the WD, the one or more flexACKs being received on at least a second sub-channel of the single operating channel and comprising acknowledgement information related to the reception by the WD of the one or more packets on the first sub-channel, the first and second sub-channels being different.

Embodiment A2. The NN of any Embodiment A1, wherein the acknowledgement information comprises information about successful and/or unsuccessful reception of the one or more packets.

Embodiment A3. The NN of any one of Embodiments A1 and A2, wherein the NN is configured to communicate with the WD using a single channel parallel packets (SCPP) mode over several sub-channels of the single operating channel.

Embodiment A4. The NN of Embodiment A3, wherein the one or more flexACKs are transmitted using a subset of the sub-channels of the single operating channel, and wherein the subset of the sub-channels may include one or more sub-channels that were not used for transmission of the one or more packets.

Embodiment A5. The NN of Embodiment A4, wherein the choice of subset of the sub-channels is based on a listen-before-talk (LBT) process where the WD checks availability of sub-channels.

Embodiment A6. The NN of any one of Embodiments A1-A5, wherein the one or more flexACKs are transmitted in parallel using all the sub-channels that were used for transmission of the one or more packets.

Embodiment A7. The NN of any one of Embodiments A1-A6, wherein the one or more flexACKs are transmitted only after the transmission duration of all parallel packets is completed.

Embodiment A8. The NN of any one of Embodiments A1-A7, wherein start times of transmission of multiple parallel flexACKs are aligned.

Embodiment A9. The NN of any one of Embodiments A1-A8, wherein the one or more flexACKs are transmitted on one or more sub-channels while still receiving one or more packets on one or more other sub-channels.

Embodiment A10. The NN of any one of Embodiments A1-A9, wherein end times of transmission of multiple parallel flexACKs are aligned.

Embodiment A11. The NN of Embodiment A10, wherein
transmit parameters used for preparing the multiple parallel flexACKs are not identical, the transmit parameters including one or more of modulation and coding schemes, number of spatial streams, and transmit powers.

Embodiment A12. The NN of any one of Embodiments A1-A11, wherein the acknowledgement information comprised in two or more flexACKs is identical to improve robustness and reliability of the flexACK transmissions.

Embodiment A13. The NN of any one of Embodiments A1-A12, wherein additional information is sent at the same time as the one or more flexACKs using one or more of the sub-channels, the additional information comprising one or more of buffer status reports, link adaptation feedback, channel quality feedback.

Embodiment A14. The NN of any one of Embodiments A1-A13, wherein the NN and/or the WD undertake specific acknowledgement related signaling for determining how the one or more flexACKs are communicated.

Embodiment A15. The NN of Embodiment A14, wherein at least some of the specific acknowledgement related signaling occurs one or more of:
during or before the transmission of the one or more flexACKs;
during transmission of multiple parallel packets;
using a control frame; and
using a management frame.

Embodiment A16. The NN of any one of Embodiments A1-A15, wherein the NN is configured to communicate with WD using wireless communication based on a Wireless Local Area Network technology according to one or more IEEE 802.11 standards.

Embodiment A17. The NN of any one of Embodiments A1-A16, wherein bandwidths of the one or more flexACKs are integer multiples of one or more of 20 MHz and a clear channel assessment (CCA) resolution bandwidth.

Embodiment A18. The NN of any one of Embodiments A1-A17, wherein communication of acknowledgement information is performed using license-exempt frequency spectrum.

Embodiment B1. A method in a network node (NN) configured to communicate with a wireless device (WD), the method comprising:
transmitting one or more packets to the WD on a first sub-channel of a single operating channel; and
receiving one or more flexible acknowledgements (flexACKs) from the WD, the one or more flexACKs being received on at least a second sub-channel of the single operating channel and comprising acknowledgement information related to the reception by the WD of the one or more packets on the first sub-channel, the first and second sub-channels being different.

Embodiment B2. The method of Embodiment B1, the method comprising one or more steps corresponding to any one of Embodiments A2-A18.

Embodiment C1. A wireless device (WD) configured to communicate with a network node (NN), the WD configured to, and/or comprising a radio interface and/or comprising processing circuitry configured to:
receive one or more packets from the NN on a first sub-channel of a single operating channel; and
transmit one or more flexible acknowledgements (flexACKs) to the NN, the one or more flexACKs being transmitted on at least a second sub-channel of the single operating channel and comprising acknowledgement information related to the reception by the WD of the one or more packets on the first sub-channel, the first and second sub-channels being different.

Embodiment C2. The WD of Embodiment C1, wherein the acknowledgement information comprises information about successful and/or unsuccessful reception of the one or more packets.

Embodiment C3. The WD of any one of Embodiments C1 and C2, wherein the WD is configured to communicate with the NN using a single channel parallel packets (SCPP) mode over several sub-channels of the single operating channel.

Embodiment C4. The WD of Embodiment C3, wherein the one or more flexACKs are transmitted using a subset of the sub-channels of the single operating channel, and wherein the subset of the sub-channels may include one or more sub-channels that were not used for transmission of the one or more packets.

Embodiment C5. The WD of Embodiment C4, wherein the choice of subset of the sub-channels is based on a listen-before-talk (LBT) process where the WD checks availability of sub-channels.

Embodiment C6. The WD of any one of Embodiments C1-C5, wherein the one or more flexACKs are transmitted in parallel using all the sub-channels that were used for transmission of the one or more packets.

Embodiment C7. The WD of any one of Embodiments C1-C6, wherein the one or more flexACKs are transmitted only after the transmission duration of all parallel packets is completed.

Embodiment C8. The WD of any one of Embodiments C1-C7, wherein start times of transmission of multiple parallel flexACKs are aligned.

Embodiment C9. The WD of any one of Embodiments C1-C8, wherein the one or more flexACKs are transmitted on the one or more sub-channels while still receiving one or more packets on one or more other sub-channels.

Embodiment C10. The WD of any one of Embodiments C1-C9, wherein end times of transmission of multiple parallel flexACKs are aligned.

Embodiment C11. The WD of any Embodiment C10, wherein
transmit parameters used for preparing the multiple parallel flexACKs are not identical, the transmit parameters including one or more of modulation and coding schemes, number of spatial streams, and transmit powers.

Embodiment C12. The WD of any one of Embodiments C1-C11, wherein the acknowledgement information comprised in two or more flexACKs is identical to improve robustness and reliability of the flexACK transmissions.

Embodiment C13. The WD of any one of Embodiments C1-C12, wherein additional information is sent at the same time as the one or more flexACKs using one or more of the sub-channels, the additional information comprising one or more of buffer status reports, link adaptation feedback, channel quality feedback.

Embodiment C14. The WD of any one of Embodiments C1-C13, wherein the NN and/or the WD undertake specific acknowledgement related signaling for determining how the one or more flexACKs are communicated.

Embodiment C15. The WD of Embodiment C14, wherein at least some of the specific acknowledgement related signaling occurs one or more of:
during or before the transmission of the one or more flexACKs;
during transmission of multiple parallel packets;
using a control frame; and
using a management frame.

Embodiment C16. The WD of any one of Embodiments C1-C15, wherein the WD is configured to communicate with NN using wireless communication based on a Wireless Local Area Network technology according to one or more IEEE 802.11 standards.

Embodiment C17. The WD of any one of Embodiments C1-C16, wherein bandwidths of the one or more flexACKs are integer multiples of one or more of 20 MHz and a clear channel assessment (CCA) resolution bandwidth.

Embodiment C18. The WD of any one of Embodiments C1-C17, wherein communication of acknowledgement information is performed using license-exempt frequency spectrum.

Embodiment D1. A method in a wireless device (WD) configured to communicate with a network node (NN), the method comprising:
receiving one or more packets from the NN on a first sub-channel of a single operating channel; and
transmitting one or more flexible acknowledgements (flexACKs) to the NN, the one or more flexACKs being transmitted on at least a second sub-channel of the single operating channel and comprising acknowledgement information related to the reception by the WD of the one or more packets on the first sub-channel, the first and second sub-channels being different.

Embodiment D2. The method of Embodiment D1, the method comprising one or more steps corresponding to any one of Embodiments C2-C18.

1. A network node, (NN) configured to communicate with a wireless device, (WD), the NN comprising a radio interface and processing circuitry to configure the network node to:
transmit one or more packets to the WD on a first sub-channel of a single operating channel; and
receive one or more acknowledgements (ACKs) from the WD, the one or more ACKs being received on at least a second sub-channel of the single operating channel and comprising acknowledgement information related to the reception by the WD of the one or more packets on the first sub-channel, the first and second sub-channels being different.

2. The NN of claim 1, wherein the acknowledgement information comprises information about one or both successful and unsuccessful reception of the one or more packets.

3. The NN of claim 1, wherein the NN is configured to communicate with the WD using a single channel parallel packets (SCPP) mode over several sub-channels of the single operating channel.

4. The NN of claim 3, wherein the one or more ACKs are received using a subset of the sub-channels of the single operating channel, and wherein the subset of the sub-channels may include one or more sub-channels that were not used for transmission of the one or more packets.

5. (canceled)

6. The NN of claim 1, wherein the one or more ACKs are received in parallel using all the sub-channels that were used for transmission of the one or more packets.

7. The NN of claim 1, wherein the one or more ACKs are received only after the transmission duration of all parallel packets is completed.

8. The NN of claim 1, wherein the one or more ACKs are received on one or more sub-channels while still receiving one or more packets on one or more other sub-channels.

9. The NN of claim 1, wherein start times of reception of multiple parallel ACKs are aligned.

10. The NN of claim 1, wherein end times of reception of multiple parallel ACKs are aligned.

11. The NN of claim 1, wherein transmit parameters used for preparing the multiple parallel ACKs are not identical, the transmit parameters including one or more of modulation and coding schemes, number of spatial streams, and transmit powers.

12. The NN of claim 1, wherein the acknowledgement information comprised in two or more ACKs is identical to improve robustness and reliability of the ACK transmissions.

13. The NN of claim 1, wherein additional information is received at the same time as the one or more ACKs using one or more of the sub-channels, the additional information comprising one or more of buffer status reports, link adaptation feedback, channel quality feedback.

14. The NN of claim 1, wherein one or both of the NN and the WD undertake specific acknowledgement related signaling for determining how the one or more ACKs are communicated.

15. The NN of claim 14, wherein at least some of the specific acknowledgement related signaling occurs one or more of:
during or before the transmission of the one or more ACKs;
during transmission of multiple parallel packets;
using a control frame; and
using a management frame.

16. The NN of claim 1, wherein the NN is configured to communicate with the WD using wireless communication based on a Wireless Local Area Network technology according to one or more IEEE 802.11 standards.

17. The NN of claim 1, wherein bandwidths of the one or more ACKs are integer multiples of one or more of 20 MHz and a clear channel assessment (CCA) resolution bandwidth.

18. The NN of claim 1, wherein communication of acknowledgement information is performed using license-exempt frequency spectrum.

19. A method in a network node, (NN) configured to communicate with a wireless device, (WD), the method comprising:
transmitting one or more packets to the WD on a first sub-channel of a single operating channel; and
receiving one or more acknowledgements (ACKs) from the WD, the one or more ACKs being received on at least a second sub-channel of the single operating channel and comprising acknowledgement information related to the reception by the WD of the one or more packets on the first sub-channel, the first and second sub-channels being different.

20.-36. (canceled)

37. A wireless device, (WD) configured to communicate with a network node, (NN), the WD comprising a radio interface and processing circuitry to configure the WD to:
receive one or more packets from the NN on a first sub-channel of a single operating channel; and
transmit one or more acknowledgements (ACKs) to the NN, the one or more ACKs being transmitted on at least a second sub-channel of the single operating channel and comprising acknowledgement information related to the reception by the WD of the one or more packets on the first sub-channel, the first and second sub-channels being different.

38.-54. (canceled)

55. A method in a wireless device, (WD) configured to communicate with a network node, (NN), the method comprising:
receiving one or more packets from the NN on a first sub-channel of a single operating channel; and
transmitting one or more acknowledgements (ACKs) to the NN, the one or more ACKs being transmitted on at least a second sub-channel of the single operating channel and comprising acknowledgement information related to the reception by the WD of the one or more packets on the first sub-channel, the first and second sub-channels being different.

56.-72. (canceled)
